(19) United States
(12) Patent Application Publication
(10) Pub. No.: US 2026/0194552 A1
(43) Pub. Date: Jul. 9, 2026

(54) METHOD FOR CONTROLLING LIQUID TRANSPORT IN FLOW PATH OF BIOMOLECULE ANALYZER USING COMPUTER, AND BIOMOLECULE PURIFICATION SYSTEM

(71) Applicant: HITACHI HIGH-TECH CORPORATION, Tokyo (JP)

(72) Inventors: Sayaka TEZUKA, Tokyo (JP); Tatsuo NAKAGAWA, Tokyo (JP)

(21) Appl. No.: 18/863,716

(22) PCT Filed: Jul. 14, 2022
(86) PCT No.: PCT/JP2022/027757

§ 371 Date: Nov. 7, 2024

(51) Int. Cl. G01N 35/10; G01N 35/00

(52) U.S. Cl. CPC G01N 35/1097; G01N 35/00584; G01N 2035/00475

(57) ABSTRACT

The biomolecule analyzer includes a first chamber storing a first liquid, a second chamber storing a second liquid, a membrane chamber having a purification membrane, and a waste liquid chamber. The method includes controlling, by the computer, transport of the second liquid until the second liquid exceeds at least a junction between a first flow path leading from the first chamber to the waste liquid chamber and a second flow path extending from the second chamber, and discharging a fluid different from the first and second liquids from the second flow path, controlling, by the computer, transport of the first liquid from the first chamber to the waste liquid chamber via the membrane chamber, and controlling, by the computer, transport of the second liquid in the second chamber from the second chamber to the membrane chamber.

### TECHNICAL FIELD

The present disclosure relates to a method for controlling liquid transport in a flow path of a biomolecule analyzer by a computer, and a biomolecule purification system.

### BACKGROUND ART

When the gene is analyzed, for example, lysing a sample and purifying and amplifying a nucleic acid are performed as pretreatment, and then an amplified product is detected. This process involves a risk of contamination and complicated sample adjustment. Therefore, conventionally, there has been a general flow in which a sample is sent to an environment equipped with experimental facility such as a laboratory, and a technician having specialized knowledge and techniques performs sample adjustment and measurement to analyze data. However, problems include that it takes time to transport the sample and that a large equipment cost and labor cost are required to maintain the experimental facility. In addition, in a case where batch processing is introduced to increase efficiency, it is difficult to interrupt an urgent sample.

In recent years, a StoA (Sample-to-answer) system that performs from reception of a sample to acquisition of measurement and data fully automatically has appeared in various fields. A flow path chip in which a chamber, a flow path, and a reagent are integrated may be used in the StoA system. By introducing the flow path chip, the following advantages can be obtained. That is, (i) measurement can be easily performed by a non-expert, (ii) data can be acquired in a short time, (iii) a highly portable device can be designed, (iv) variation derived from a procedure is reduced, and (v) storage of a reagent is facilitated.

The fields of application of the StoA flow path chip include, for example, forensic medicine, in vitro diagnosis, identification of species of animals and plants, biodefense, medicine, biotechnology, life science, defense, public health, and agriculture, including potential applications. In a case where gene analysis is performed on the StoA flow path chip, it is desirable that a part or the whole of the flow path directly touching the sample is disposable for each measurement in order to prevent the sample from mixing between the analyses. In order to reduce the cost of the disposable chip, there are measures such as a design that is easy to manufacture and the use of an inexpensive material.

However, in such an inexpensive chip, the pressure resistance of the chip is limited by a valve, chip bonding strength, and the like. For example, in the case of PTL 1, the flow path chip has a simple structure in which two thermoplastic resins are bonded together. The pressure resistance of this chip is limited by a valve, and is described to be 68 kPa. For example, in the case of PTL 2, it is described that the pressure resistance of the flow path chip is, for example, 124 kPa. By contrast, in the case of large-scale flow path systems, for example in liquid chromatography, the pressure that can be used for solution transport is more than a several MPa. In the case of spin columns which are widely used in the purification of nucleic acids, it is possible to apply pressures of up to 500 kPa. As described above, the pressure that can be used when sample processing is performed in the StoA flow path chip tends to be lower than that in a bench top system.

In the StoA system, it is necessary to automatically complete the transport of the solution with a limited space and pressure. Thus, it is not preferable that air bubbles is present in the flow path. This is because there is a concern that the transport of the solution becomes incomplete or an unexpected operation is caused by the air being sandwiched in the flow path. In order to solve the problem caused by the presence of air in such a flow path, according to NPL 1, a material through which air escapes is used for the flow path. According to NPL 2 and PTL 3, a structure for removing air is installed in a flow path. It is also possible to solve the problem by compressing or moving the air under high pressure.

### CITATION LIST

### Patent Literature

PTL 1: U.S. Pat. No. 10,233,491
PTL 2: U.S. Pat. No. 9,354,199
PTL 3: Japanese Patent No. 6613212

### Non-Patent Literature

NPL 1: “PDMS membranes with tunable gas permeability for microfluidic applications-RSC Advances (RSC Publishing) DOI: 10.1039/C4RA1293B,” RSC Adv., 2014, 4, 61415
NPL 2: “Integrated Microfluidic System for Rapid Forensic DNA Analysis: Sample Collection to DNA Profile/Analytical Chemistry (acs.org), “Anal. Chem. 2010, 82, 16, 6991-6999

### SUMMARY OF INVENTION

### Technical Problem

In purification and recovery of nucleic acid using a purification membrane such as silica, high recovery efficiency can be achieved with a simple flow path structure. However, in a case where this purification method is performed in a flow path having a limited space through which air can escape, the following problems occur. When air enters the chamber in which the membrane is stored, the air must cross the membrane chamber. For example, after a lysate passes through a membrane, when air passes through t the membrane while the membrane is wetted with the lysate, the applied pressure needs to exceed a Laplace pressure P_{L} defined by the following Expression (1).

$$\begin{matrix}[ Math . 1 ] & \\ {P}_{L} = \frac{4 γ cos θ}{d} & ( 1 )\end{matrix}$$

Here, θ, d, and γ are the contact angle between the liquid wetting the film and the film, the pore diameter of the membrane, and the surface tension of the liquid, respectively. In a case where a fine pore silica membrane is used for purification, the Laplace pressure is considered to be significantly high because d is small.

In this regard, by providing a structure for venting air as in the techniques disclosed in PTL 3, NPL 1, and NPL 2, it is also possible to avoid air from passing through the membrane.

However, in a case where this approach is adopted, an additional structure must be provided in the flow path. With regard to this additional structure, there is a restriction on usable materials, or there is a concern about an increase in cost and size of the chip by providing an additional structure.

Furthermore, in the case of PTL 1, the purification membrane installed in the purification chamber does not cover the entire surface of the flow path. In this case, since the air goes beyond the side of the purification membrane, the above-described problem does not occur. However, since the ratio of the lysate in contact with the membrane decreases, there is a concern that the recovery rate decreases.

In view of such a situation, the present disclosure proposes a technique for preventing a fluid (air, nitrogen, and other gases) from exceeding a purification membrane even without an additional flow path structure.

### Solution to Problem

In order to solve the above problems, the present disclosure is, as an example, a method for controlling liquid transport in a flow path of a biomolecule analyzer by a computer. The biomolecule analyzer includes a first chamber storing a first liquid, a second chamber storing a second liquid, a membrane chamber having a purification membrane, and a waste liquid chamber. The method includes controlling, by the computer, transport of the second liquid until the second liquid exceeds at least a junction between a first flow path leading from the first chamber to the waste liquid chamber and a second flow path extending from the second chamber, and discharging a fluid different from the first and second liquids from the second flow path, controlling, by the computer, transport of the first liquid from the first chamber to the waste liquid chamber via the membrane chamber, and controlling, by the computer, transport of the second liquid in the second chamber from the second chamber to the membrane chamber.

Further features related to the present disclosure will become apparent from the description of the present description and the accompanying drawings. Aspects of the present disclosure are achieved and realized by elements, combinations of various elements, and aspects of the following detailed description and appended claims. The description herein is merely exemplary and is not intended to limit the scope of the claims or application examples of the present disclosure in any way.

### Advantageous Effects of Invention

According to the technology of the present disclosure, it is possible to prevent air from exceeding the purification membrane even without an additional flow path structure.

### BRIEF DESCRIPTION OF DRAWINGS

FIG. 1 is a diagram illustrating a configuration example of a biomolecule analyzer 100 according to the present embodiment.

FIG. 2 is a diagram illustrating a derivative form of a part of the biomolecule analyzer 100 and a flow path chip 114.

FIG. 3 is a diagram illustrating a procedure example of performing biological analysis using the biomolecule analyzer 100.

FIG. 4 is a diagram illustrating an internal configuration example of a computer 115.

FIG. 5 is a diagram illustrating a configuration example of a purification system 301 including a main part of a flow path chip 114 according to a first example, which is a main part of the flow path chip 114 at the time of completing or performing a sample lysing procedure 202.

FIG. 6 a diagram illustrating purification processes I to V according to the first example.

FIG. 7 is a flowchart corresponding to the process illustrated in FIG. 6.

FIG. 8 is a diagram for explaining a purification process according to a comparative example.

FIG. 9 is a flowchart of a purification process according to FIG. 8.

FIG. 10 is a schematic view illustrating a position of a solution during transporting and a diagram illustrating a pressure change measured accordingly in the experiment of the first example.

FIG. 11 is a diagram illustrating a configuration example of a purification system 400 including a main part of a flow path chip 114 according to a second example, which is a main part of the flow path chip 114 at the time of completing or performing a sample lysing procedure 202.

FIG. 12 is a diagram for explaining purification processes I to V according to the second example.

FIG. 13 is a diagram illustrating a configuration example of a purification system 500 including a main part of a flow path chip 114 according to a third example, which is a main part of the flow path chip 114 at the time of completing or performing a sample lysing procedure 202.

FIG. 14 is a diagram for explaining purification processes I to V according to the third example.

FIG. 15 is a flowchart corresponding to the purification process illustrated in FIG. 14.

FIG. 16 is a diagram illustrating a configuration example of a purification system 600 including a main part of a flow path chip 114 according to a fourth example, which is a main part of the flow path chip 114 at the time of completing or performing a sample lysing procedure 202.

FIG. 17 is a diagram for explaining purification processes I to V according to the fourth example.

FIG. 18 is a diagram for explaining purification processes I to V according to a fifth example.

FIG. 19 is a diagram for explaining purification processes I to V according to a sixth example.

### DESCRIPTION OF EMBODIMENTS

The present embodiment proposes a technique of installing a purification membrane without requiring structural robustness in a flow path chip by reducing a pressure required for liquid transport in the flow path chip through each example. First, each feature of the biomolecule analyzer according to the present embodiment will be described, and then description of each example will be made. In the accompanying drawings of this application, functionally same elements may be denoted by the same numbers. Note that, although the accompanying drawings illustrate specific embodiments and implementation examples conforming to the principles of the present disclosure, these are for understanding the present disclosure and are not used to interpret the present disclosure in a limited manner. Furthermore, in the present embodiment, the description has been made in sufficient detail for those skilled in the art to implement the present disclosure, but it is necessary to understand that other implementations and modes are possible, and changes in configurations and structures and replacement of various elements are possible without departing from the scope and spirit of the technical idea of the present disclosure. Therefore, the following description should not be interpreted as being limited thereto.

In the embodiments of the present disclosure, the computer-controlled operation may be implemented by software running on a general-purpose computer, or may be implemented by dedicated hardware or a combination of software and hardware.

### (1) Features of Biomolecule Analyzer

### <Flow Path Chip>

In the present embodiment, the “flow path chip (or simply a chip)” refers to a disposable or multi-use cartridge including a reagent, a chamber, and a flow path therein. The flow path chip may include a solution transport power source therein. Some or all of the reagents may be present in the chip. A part of the chamber may have a temperature control function, a function of capturing molecules, a detection function, and a voltage application function.

The material of the flow path chip is not particularly limited as long as it is a material generally used in the technical field. For example, polypropylene, a cyclic olefin polymer (COP), a cyclic olefin copolymer (COC), polycarbonate, polyethylene terephthalate, or polyurethane is preferably used as a material having a small DNA adsorption amount. It is also desirable to suppress the adsorption amount by modifying the surface so as to be negatively charged. Examples of other materials include metals such as gold, silver, copper, aluminum, tungsten, molybdenum, chromium, platinum, titanium, and nickel; alloys such as stainless steel, hastelloy, inconel, monel, and duralumin; silicon; glass materials such as glass, quartz glass, fused quartz, synthetic quartz, alumina, sapphire, ceramics, forsterite and photosensitive glass; plastics such as polyester resins, polystyrene, polyethylene resins, ABS resins (acrylonitrile butadiene styrene resins), dimethylpolysiloxane (PDMS), nylon, acrylic resins, fluororesins, polycarbonate resins, polyurethane resins, methylpentene resins, phenol resins, melamine resins, epoxy resins and vinyl chloride resins; agarose, dextran, cellulose, polyvinyl alcohol, nitrocellulose, chitin, chitosan, or any combination thereof.

If the cross-sectional area of the flow path is too large, there is a concern that liquid residue or sample loss occurs. In addition, if the cross-sectional area is too large, it is difficult to apply pressure. On the other hand, when the cross-sectional area is too small, there is a problem that a high pressure is required for transporting the solution or the time required for transporting the solution becomes long. Therefore, the cross-sectional area of the flow path can be in the range of 1 μm² to 314 mm². The cross-sectional area can be in the range of 400 μm² to 100 mm² as a more preferable configuration. The cross-sectional area can be in the range of 0.01 mm² to 10 mm² as a still more preferable configuration.

If the length of the flow path is too short, elements such as valves are difficult to be incorporated. If the length of the flow path is too long, there is a concern that the chip may be increased in size. Therefore, the length of the flow path connecting the configurations of the chip can be 1 μm to 100 cm. A more preferable range can be 1 mm to 50 cm. A still more preferable range can be 5 mm to 30 cm.

### <Chamber>

The chamber means a space in which liquid or solid can be stored, and has a diameter equal to or larger than that of the flow path. The reagent may be stored in the chamber, and PCR, lysis, purification, or the like may be performed in the chamber.

The volume of the chamber is, for example, 0.01 μL to 10 L. When the volume is larger than 10 L, it is difficult to carry the device. As a more preferred example, the volume of the chamber can be 0.1 μL to 2 L. Note that all the chambers do not need to be installed in the chip, and may be provided in the device main body or another independent chip.

In a case where the chamber is installed in the chip, the volume of the chamber can be 0.01 μL to 50 mL. When the volume is larger than 50 mL, the chip becomes huge, and it becomes difficult to store the chip.

The chip stores one or more reagents in one or more reagent storage chambers. When these reagents are mixed at an unintended timing, performance is deteriorated, and other unexpected results are caused. Therefore, it is desirable that these reagents are separated by a partition mechanism including a valve, a film, air, a flow path that is thin enough to prevent spontaneous mixing, or a combination thereof until immediately before use. By isolating the reagent from the outside air, long-term storage and portability of the chip are realized.

Similarly, in a case where the reagent is stored outside the chip (in a case where the chamber is externally attached to the flow path chip), the reagent is desirably stored in a state of being isolated from the outside air, and is separated from other purification system components by a valve, a film, air, or the like.

### <Purification System>

In the present embodiment, the “purification system” means a system in which a purification membrane provided in a flow path chip and a membrane chamber storing the purification membrane capture biomolecules contained in the lysate stored in the lysis chamber, and subsequently wash the lysate with a wash buffer stored in a wash buffer chamber.

The lysis chamber and the wash buffer chamber may be provided outside the flow path chip, or either may be provided in the chip.

The purification system may be configured to selectively recover specific biomolecules. For example, DNA can be selectively extracted from a liquid containing proteins, DNA, ions, and the like. The purification system may be a purification system for recovering a molecule containing RNA, a biopolymer (nucleic acids, proteins, lipids, polysaccharides), a biomonomer (amino acids, lipids, sugars, nucleobases), and a derivative thereof in the structure. A system for recovering a plurality of kinds of these molecules may be used. As an example, there is a system capable of recovering DNA and RNA in which a silica membrane is adopted as a purification membrane.

### <Sample Type>

The sample to be subjected to the purification system according to the present embodiment is not particularly limited as long as it is a sample derived from an organism. The organism from which the sample is derived is not particularly limited, and a sample derived from any organism such as a vertebrate (for example, mammals, birds, reptiles, fish, amphibians, and the like), an invertebrate (for example, insects, nematodes, crustaceans, and the like), a plant, a protist, a plant, a fungus, a bacterium, or a virus can be used.

When a sample is collected, a swab, filter paper, cloth, or the like can be used as a carrier. The carrier may be introduced into the purification system together with the carrier.

### <Lysate>

When transporting the sample to the membrane chamber, the sample needs to be in a form capable of flowing through the flow path. Therefore, in a case where the state of the sample is solid (for example, a swab sample), it is preferable to dissolve or suspend the solid sample in a lysis buffer to obtain a fluid lysate. The sample does not need to be completely dissolved. A site that exhibits a solid or high viscosity after lysis may be retained in the lysis chamber. In a case where the sample is a gas sample (for example, air, exhalation, and the like), it is preferable to obtain a liquid sample by suspending cells contained in the gas sample in a solvent. Preparation methods for making a sample into a lysate are customary in the art and can be readily understood by those skilled in the art. For example, the lysis buffer can contain a chlorinated material, such as calcium hypochlorite. As another example, the substance can include enzymatic activities such as DNAase, RNAase, protease, and the like. If necessary, the lysis buffer may contain a substance that facilitates release of biomolecules such as Chaotrope, a surfactant, and KOH, or a substance that facilitates binding of nucleic acid to the purification membrane. If necessary, the mixture may be subjected to processing such as heating and stirring.

In the present embodiment, the “lysate” means a substance obtained by converting a sample derived from an organism into a liquid having a viscosity of 100,000 mPa·s or less using a lysis buffer. As a more preferred state, the lysate may have a viscosity of 10,000 mPa·s or less. As a still more preferred state, the lysate may have a viscosity of 1000 mPa·s or less.

### <Solution Transport Control>

A valve may be used for transport control of the solution. Solution control by flow path resistance may be performed.

In the present embodiment (each example), air pressure is used as solution transport power. Air pressure, mechanical compression, centrifugal force, or the like may be used as the solution transport power.

If the pressure used for the transport is too high, the pressure exceeds the pressure resistance of the chip. If the pressure used for the transport is too low, the time required for the transport becomes long, which leads to an extension of the measurement time. Therefore, the pressure used for transport can be in the range of 0.1 kPa to 1 MPa. In a narrower range, the transport of the solution can be completed at 0.1 kPa to 500 kPa, and in an even narrower range, at 0.1 kPa to 200 kPa. The time used for transport can be up to 1 hour per step, 10 minutes in a narrower range, and 5 minutes in a still narrower range. If the amount of liquid to be transported is too large, the time and pressure required for transport increase, the cost of the chip increases, and the cost of the reagent also increases. Therefore, the amount of liquid to be transported can be 1 L or less, 10 mL or less in a narrower range, and 2 mL or less in a still narrower range per reagent.

### <Wash Buffer>

In the present embodiment, the “wash buffer” means a liquid that is used to wash away substances adhering to the purification membrane and unnecessary for subsequent steps. The wash buffer may not be able to wash away all unnecessary substances, and may wash away some or all necessary substances.

According to the above Expression (1), in the present embodiment, a wash buffer having the following features can be used. First, those having a higher evaporation speed than the lysate are suitable. In addition, it is desirable that the lysate and the wash buffer are compatible. Furthermore, it is desirable that the contact angle with the purification membrane is smaller (wettability is lower) or the interfacial tension is lower than that of the lysate. Examples of the wash buffer satisfying such a requirement include ethanol and isopropanol. A liquid containing 10% or more of these alcohols can also be used as the wash buffer. A solution that does not satisfy the above conditions may also be used.

The number of wash buffers may be one or two or more. By using two or more kinds of wash buffers, it is possible to perform washing more efficiently. These wash buffers may be stored in one chamber or may be stored in two or more chambers. In a case where two or more types of wash buffers are used, air may or may not be interposed between the two or more types of wash buffers. However, in a case where the second and subsequent wash buffers have a higher evaporation rate, a lower surface tension, or a smaller contact angle with respect to the purification membrane than the first wash buffer, it is desirable to continuously transport them.

### <Purification Membrane>

Examples of the type of the membrane include a silica membrane. Other examples of the purification membrane can include a solid substrate mainly composed of cellulose capable of adsorbing DNA, carboxylated particles, and an ion exchange resin. In particular, a membrane having a hydroxyl group or a silica group on the surface can be used. The membrane may be any membrane as long as it can hold particles of 100 μm or more. The thickness of the membrane is preferably 1 μm or more. Since DNA can be more efficiently recovered as the membrane pore is finer, it is possible to use a membrane capable of holding particles of 10 μm or more, more preferably 1 μm or more, and still more preferably 0.1 μm or more.

If the volume of the purification membrane is too small, the amount of biomolecule that can be adsorbed is reduced. On the other hand, if the volume of the purification membrane is too large, there is a concern that the possibility that unintended molecular adsorption occurs in purification or in a subsequent step, or the transport efficiency of the solution deteriorates. In each of the examples described later, a membrane having an area of 12.5 mm² is used. For example, a membrane having an area of 1 mm² to 314 mm² can also be used, and the size of the membrane is not limited.

### <Detection Method>

Downstream of the present purification system, amplification is performed by PCR. After amplification, detection by capillary electrophoresis (CE) is performed. As other examples, it is possible to use massively parallel sequencing (MPS), pyrosequencing, sanger sequencing, nanopore sequencing, chromatography, electrical measurement, spectroscopy, NMR, restriction fragment length polymorphisms (RFLP), and the like.

### <Other Supplementary Items>

In all the drawings for describing the present embodiment, components having the same function are denoted by the same reference numerals, and repeated description thereof is omitted as much as possible. Hereinafter, each example of the present embodiment will be described in detail with reference to the accompanying drawings. The measurement method, the structure of the device, the type of the substance, and the material described in each example are examples for embodying the idea of the present embodiment, and do not strictly specify the measurement principle, the material and the dimension of the device, and the like. Specific pressure values described in each example are examples for embodying the idea of the present embodiment, and do not strictly specify them. The specific sample types and the composition and the amount of liquid of a purification kit described in each example are examples for embodying the idea of the present embodiment, and are not examples for strictly defining the chemical composition and time. Specific types of measurement objects and solutions and concentrations thereof described in each example are examples for embodying the idea of the present embodiment, and are not examples for strictly defining the chemical composition.

### <Configuration Example of Biomolecule Analyzer>

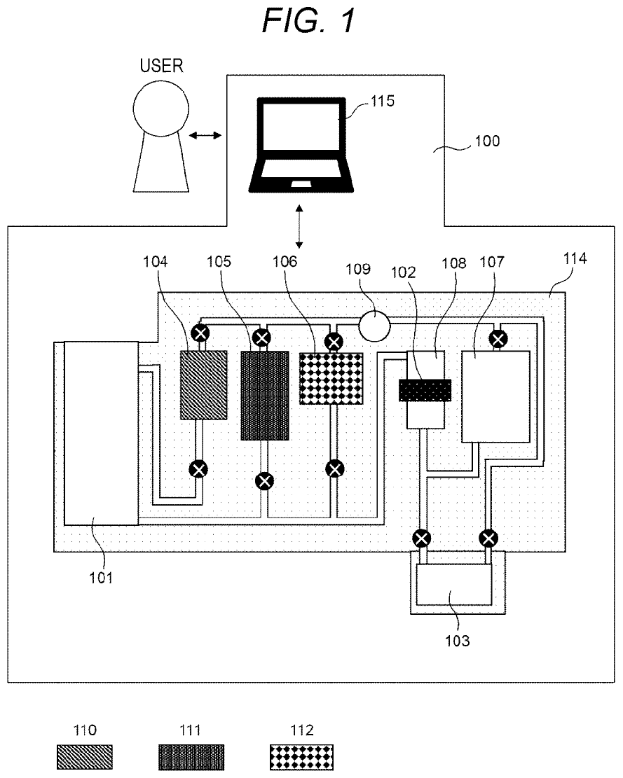

FIG. 1 is a diagram a configuration example of a biomolecule analyzer 100 according to the present embodiment. The biomolecule analyzer 100 includes a flow path chip 114 and a computer 115 for performing biomolecule analysis.

The flow path chip 114 includes a lysis chamber 101 for introducing and lysing a collected sample, a membrane chamber 108 in which a purification membrane 102 is stored, a reaction chamber 103 for amplifying DNA, a waste liquid chamber 107, and a port 109 fluidly connected to the outside of the chip. The arrangement of the chambers in the flow path chip 114 and the flow path connection between the chambers are different in each example. Therefore, the chamber arrangement, the flow path connection, and the transport operation of the lysate and the wash buffer will be described later.

As the purification membrane 102, the glass fiber membrane GF/F sold by Whatman cut out to a diameter of 4 mm has been installed. Other membranes may be used as the purification membrane 102. The diameter of the purification membrane (length in the longitudinal direction in the case of a rectangle) can be in the range of 0.1 mm to 100 mm in size.

The solution is transported by applying pressure through the port 109, and a reagent, an amplification product, and the like can be exchanged with the outside of the chip. The pressure can be applied using a pressure generator provided outside the chip. The flow path chip 114 according to FIG. 1 has a configuration including chambers 104, 105, and 106 for storing a reagent and the like. Regarding the membrane chamber 108, the volume of a portion close to the lysis chamber 101 in the space separated by the membrane is 10 μL, and the volume of a portion close to the waste liquid chamber 107 is 10 μL. The lysis buffer chamber 104 stores a lysis buffer 110 for lysing a sample. The wash buffer chamber 105 stores a wash buffer 111. The reagent chamber 106 stores an eluate or a reagent 112 used for a reaction. The above functions may be partially integrated in the same chamber. The positional relationship of the chip components described above is not limited to FIG. 1, and the connection of the flow paths may be different from that in FIG. 1.

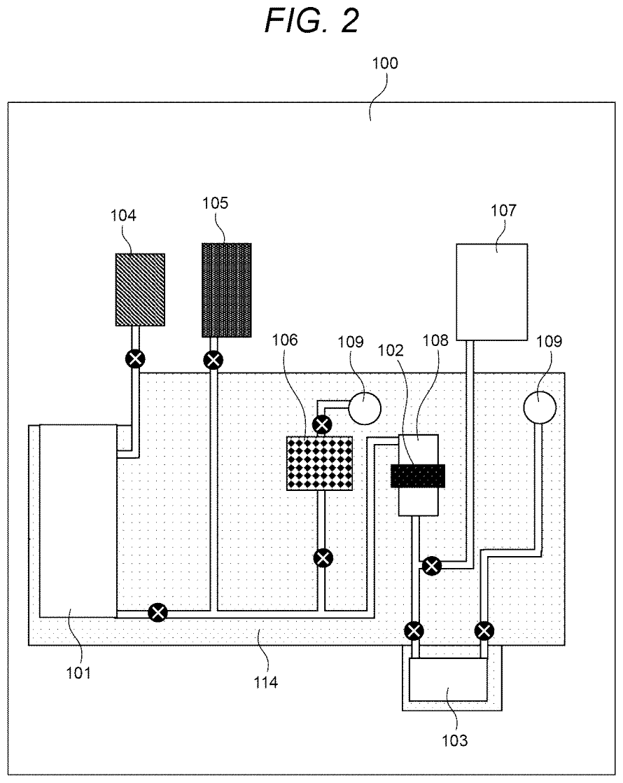

FIG. 2 is a diagram illustrating a part of the biomolecule analyzer 100 and a derivative form of the flow path chip 114. In FIG. 2, the lysis buffer chamber 104, the wash buffer chamber 105, and the waste liquid chamber 107 are provided outside the flow path chip 114. By adopting such a form, it is possible to enjoy advantages of miniaturization and cost reduction of the flow path chip 114.

### <Example of Biological Analysis Procedure>

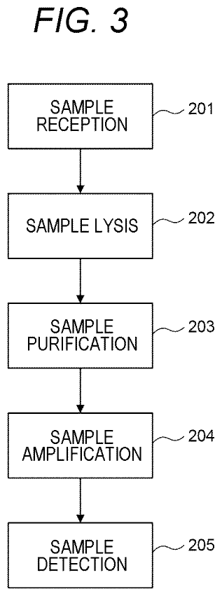

FIG. 3 is a diagram illustrating a procedure example of performing biological analysis using the biomolecule analyzer 100. As illustrated in FIG. 3, the biological analysis includes, for example, a sample receiving procedure 201, a sample lysing procedure 202, a sample generating procedure 203, a sample amplifying procedure 204, and a sample detecting procedure 205.

In the sample receiving procedure 201, the lysis buffer 110 is transported from the chamber 104 to the lysis chamber 101 before and after the sample is stored in the lysis chamber 101 (introducing the sample into the lysis chamber 101).

Next, in the sample lysing procedure 202, lysis is initiated. In sample generating procedure 203, a lysate 113 is sent from the lysis chamber 101 to the purification membrane 102 to bind DNA to the membrane and purification is performed. After purification, a step of drying the wash buffer or the like may be included. The eluted DNA is transported to the reaction chamber 103.

In the sample amplifying procedure 204, the purified DNA is amplified. In the sample detecting procedure 205, measurement of the amplified DNA is performed. The sample detecting procedure 205 may be performed in the flow path chip 114. Alternatively, the amplified DNA may be transported to a detection unit outside the flow path chip 114 to be performed by a separately provided measurement unit.

Note that the procedures 201 to 205 may be performed in parallel. Some procedures may be omitted, or other procedures may be incorporated.

### <Internal Configuration Example and Control Operation of Computer 115>

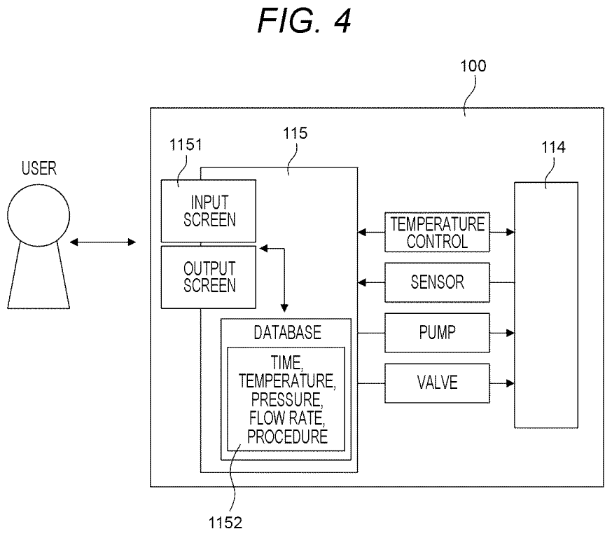

FIG. 4 is a diagram illustrating an internal configuration example of the computer 115. The computer 115 includes a processor (not illustrated), a user interface 1151, and a database (storage device) 1152.

The user interface 1151 includes an input screen and an output screen. The user interface 1151 can receive parameters related to the implementation procedure of FIG. 3, for example, time, temperature, pressure, flow rate, procedure, and the like of each step from the user and store the parameters in the database 1152. Various parameters can be stored in the database 1152 in advance.

The computer 115 can execute opening and closing of the valve of the flow path chip 114, temperature control, and control of applied pressure and flow rate on the basis of various parameters recorded in the database 1152. Furthermore, the computer 115 can automatically control all the implementation procedures illustrated in FIG. 3. Note that a part of the implementation procedure illustrated in FIG. 3 may be assisted and implemented by the user.

### (2) Examples

### First Example

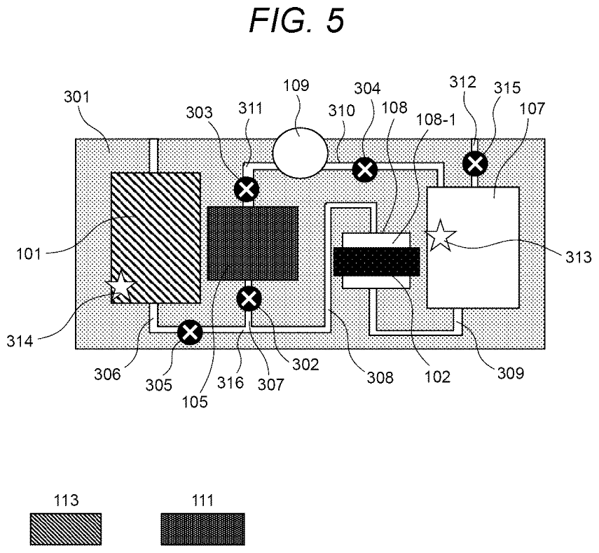

A first example will be described with reference to FIGS. 5 to 7.

### <Configuration Example of Purification System 301 Including Main Part of Flow Path Chip 114>

FIG. 5 is a diagram illustrating a configuration example of a purification system 301 including a main part of the flow path chip 114 according to the first example, that is, a main part of the flow path chip 114 at the time of completing or performing the sample lysing procedure 202.

The purification system 301 includes a lysis chamber 101, a wash buffer chamber 105, a waste liquid chamber 107, a membrane chamber 108, valves 302, 303, 304, 305, and 315, flow paths 306, 307, 308, 309, 310, 311, and 312 connecting the chambers, and a port 109. The number of the ports 109 may not be 1, and one port may be installed for each function. For example, dedicated ports may be provided to the flow paths 311 and 310, respectively.

The lysis chamber 101 holds the lysate 113 therein. The wash buffer chamber 105 holds the wash buffer 111 therein. A liquid level detection sensor 313 is installed in the waste liquid chamber 107. A liquid level detection sensor 314 is installed in the lysis chamber 101. One or more liquid level detection sensors may or may not be installed. In addition, a liquid level detection sensor may be installed in another chamber of the lysis chamber 101 or the waste liquid chamber 107.

As illustrated in FIG. 5, the flow path 306 extending from the outlet port of the lysis chamber 101 and the flow path 307 extending from the outlet port of the wash buffer chamber 105 join at a connection point (junction) 316 to form the flow path 308, which leads to the inlet port of the membrane chamber 108. The flow path 309 extending from the outlet port of the membrane chamber 108 is led to an inlet port in a lower portion (bottom surface portion: not necessarily a bottom surface) of the waste liquid chamber 107. Two flow paths 310 and 311 are extended from the port 109. The flow path 310 is led to an upper portion (top surface portion: not necessarily a top surface) of the waste liquid chamber 107. The flow path 311 is led to an inlet port of the wash buffer chamber 105. The flow path 312 is led to an upper portion (top surface portion: not necessarily a top surface) of the waste liquid chamber 107.

As illustrated in FIG. 5, the valve 302 is provided in the flow path 307. The valve 303 is provided in the flow path 311. The valve 304 is provided in the flow path 310. The valve 305 is provided in the flow path 306. The valve 315 is provided in the flow path 312.

### <Purification Process>

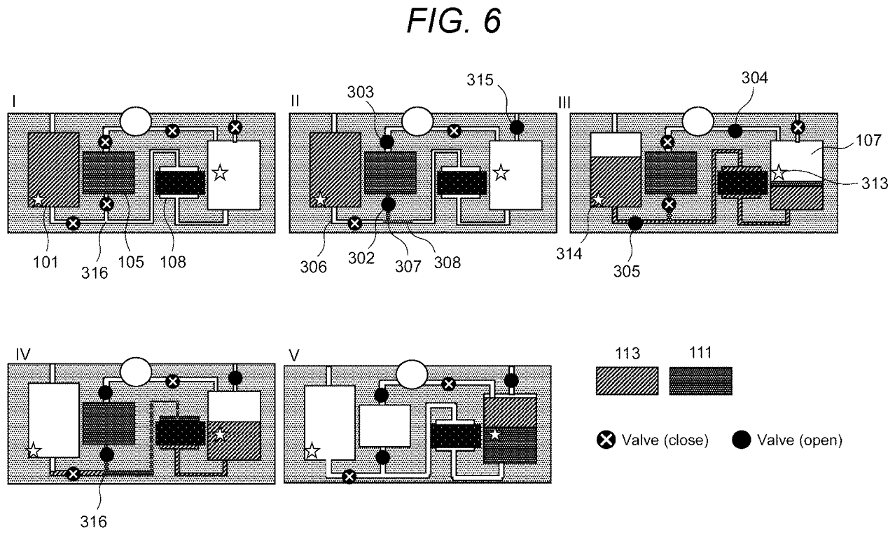

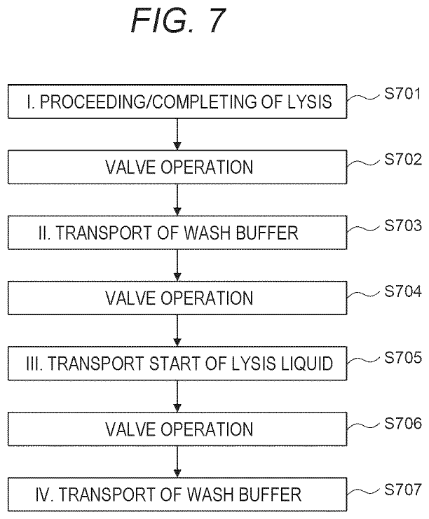

FIG. 6 is a diagram illustrating purification processes I to V according to the first example. FIG. 7 is a flowchart corresponding to the process illustrated in FIG. 6. The computer (processor) 115 controls the opening and closing of each valve and the transport of the lysate 113 and the wash buffer 111 by applying pressure in each process.

### (i) Process I

Process I shows the state during lysis or immediately after lysis is complete in the sample lysing procedure 202. The valves 302, 303, 304, 305, and 315 are then closed (step 701).

### (ii) Process II

In Process II, the valves 302, 303, and 315 are opened (step 702). The wash buffer 111 is extruded from the wash buffer chamber 105 to the membrane chamber 108 at a pressure of 30 kPa or less for a time of 30 seconds or less (step 703). At this time, the air in the flow path 307 moves to the flow path 308 or 306, and the flow path 307 is filled with the wash buffer 111. Discharging the air in the flow path 307 in Process II is important for achieving continuous transport without sandwiching air between the lysate 113 and the wash buffer 111.

(iii) Process III

In Process III, the valves 302, 303, and 315 are closed, the valves 305 and 304 are opened (step 704). 900 μL of the lysate 113 is transported from the lysis chamber 101 to the waste liquid chamber 107 via the membrane chamber 108 for 1 minute at an applied pressure of −60 kPa (step 705). The transport amount (900 μL) of the lysate 113 is controlled by the computer 115 on the basis of the liquid level detection sensor 314 and the application time (1 minute) of a predetermined pressure (60 kPa).

### (iv) Process IV

In Process IV, the valves 304 and 305 are closed and the valves 302, 303, and 315 are opened (step 706) before air following the lysate 113 exceeds the branch point (connection point (junction) 316) of the flow paths 306 and 308 and the flow path 307, and 500 μL of the wash buffer 111 is transported from the wash buffer chamber 105 to the waste liquid chamber 107 via the membrane chamber 108 for 3 minutes at an applied pressure of 60 kPa (step 707). The transport amount (500 μL) of the wash buffer 111 is controlled by the computer 115 based on the liquid level detection sensor 314 and the application time (3 minutes) of the predetermined pressure (60 kPa).

By performing the operations shown in Processes I to IV, continuous transport can be performed without air being sandwiched between the lysate 113 and the wash buffer 111.

### Comparative Example

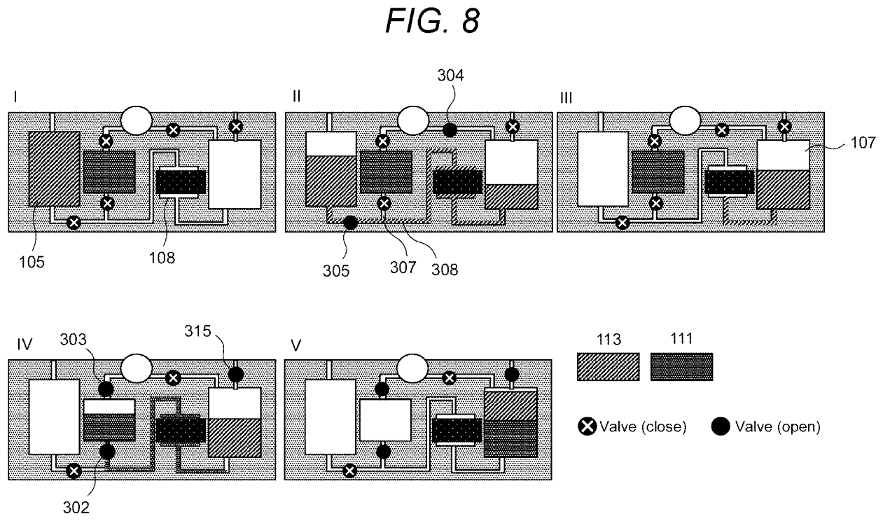

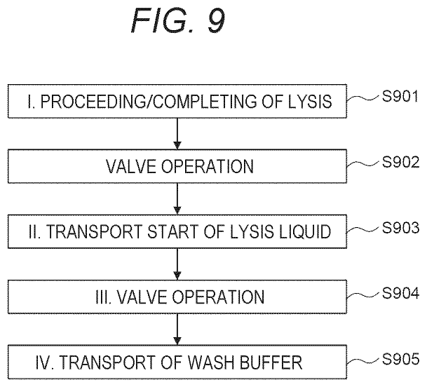

FIG. 8 is a diagram for explaining a purification process according to a comparative example. FIG. 9 is a flow chart of the purification process according to FIG. 8.

### (i) Process I

Process I shows the state during lysis or immediately after lysis is complete in the sample lysing procedure 202 (step 901). At this time, the valves 302, 303, 304, and 305 are closed.

### (ii) Process II

In Process II, the valves 304 and 305 are opened (step 902). The lysate 113 is transported from the lysis chamber 101 to the waste liquid chamber 107 via the membrane chamber 108 (step 903).

(iii) Process III

In Process III, when the transport of the lysate 113 is completed, the valves 305 and 304 are closed (step 904).

### (iv) Process IV

In Process IV, the valves 302, 303, and 315 are opened (Step 904). The wash buffer 111 is transported from the wash buffer chamber 105 to the waste liquid chamber 107 via the membrane chamber 108 (Step 905).

### (v) Process V

The process V shows the state after a total or predetermined amount of wash buffer 111 is transported to the waste liquid chamber 107 via the membrane chamber 108.

In the case of the purification process according to the comparative example, the air present in the flow paths 307 and 308 enters between the lysate 113 and the wash buffer 111. Therefore, in order for the wash buffer 111 to reach the membrane, it is necessary to exceed the Laplace pressure generated between the lysate 113 and the purification membrane 102.

### Technical Effects

In order to confirm the technical effect of the transport operation of the lysate and the wash buffer according to the first example, a comparative experiment has been conducted on the pressure required for solution transport in a case where air entered the flow path and in a case where air did not enter the flow path, using a simple flow path system. Note that, here, the technical effects will be discussed on the basis of the experimental results according to the first example. The technical effects mentioned here are the same for the second to fourth examples and the derivative examples described later.

### (i) Experimental Conditions

In the flow path system, a lysate prepared according to a Qiaamp investigator kit DNA (QIK) protocol made by Qiagen and a QIK wash buffer (AW1) were used. The lysate and the wash buffer were each placed in a 1.5 mL tube, pressurized with a syringe pump, and transported to a polycarbonate membrane chamber. The volume of the solution that the membrane chamber can hold was about 20 μL. the membrane chamber was centrally separated by the membrane, and both upstream and downstream volumes were about 10 μL. The liquid-contact area of the purification membrane was set to 3.1 mm². The lysate and the wash buffer that passed through the membrane chamber were recovered by a waste liquid tube installed behind the membrane chamber. The extrusion speed of the syringe pump was set to 4 mL/min.

In the transport (Procedure A) of the procedure (comparative example) not according to the first example, 100 μL of the lysate, 100 μL of air, and 500 μL of the wash buffer (QIK wash buffer AW1) were sequentially transported to the membrane chamber, and the time change in pressure was measured. In order to reproduce the transport method according to the first example, 100 μL of the lysate and 500 μL of the wash buffer were continuously transported without interposing air in Procedure B. As the membrane, a glass fiber membrane GF/F made by Whatman was used.

### (ii) Experimental Results

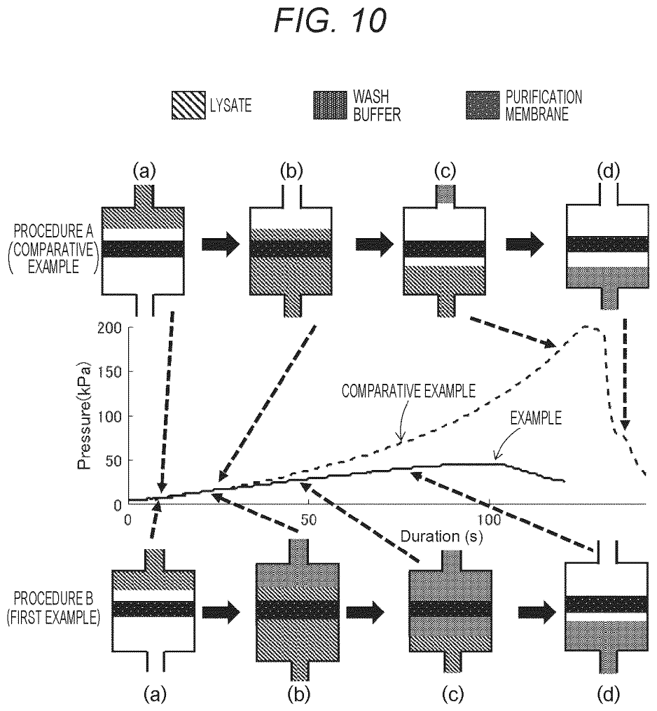

FIG. 10 is a schematic diagram illustrating the position of the solution during transporting and a diagram illustrating the pressure change measured accordingly in the experiment described above. In FIG. 10, a broken line graph indicates the result of Procedure A (comparative example), and a solid line graph indicates the result of Procedure B (first example).

Since the extrusion speed of the syringe pump has been greater than the movement speed of the solution, the pressure increased over time while the lysate passes through the membrane, to 20 kPa just before the lysate exited the membrane (FIG. 10 (solid/dashed lines) step (a)-(b)).

In the case of Procedure A, once the lysate went through and air entered the membrane, the liquid level stopped moving. Further, as the syringe pump continued to be pushed, air slowly began to cross the membrane at 80 kPa and above. When 180 kPa was reached, the wash buffer reached the membrane chamber (FIG. 10 (broken line), step (c)-(d)). It was confirmed that the wash buffer crossed the membrane, and the pressure rapidly decreased to around 30 kPa after the wash buffer was completely removed (FIG. 10 (broken line), step (d)).

In the case of Procedure B, the solution did not stop as the lysate passed through and the wash buffer entered the membrane (FIG. 10 (solid line) step (b)-(c)). The pressure did not exceed 40 kPa until the wash buffer was completely removed. Separately, the necessary pressure when the single wash buffer was transported was confirmed, and the transport was completed within 40 kPa (data not shown).

### (iii) Discussion of Experimental Results

As described above, from the experimental results of Procedure A (comparative example) and Procedure B (first example), it was confirmed that the required pressure could be reduced to ⅓ by using the transport method according to the first t example (the same applies to other examples described later).

The reason why a high pressure is not required when air enters after the wash buffer is removed is that the evaporation rate of the wash buffer is significantly higher than that of the lysate. The wash buffer (QIK, AW1) is composed of ethanol in a volume of 50% or more.

In this example, the lysate and the wash buffer were continuously transported to reduce the maximum pressure required to transport the two liquids. The effect of the present example is not limited only to the kit described above. The composition of the lysate or the wash buffer may be different. In a case where the second liquid (wash buffer) can be completely removed by the sample detecting procedure 205, the following requirements are given as a combination of the first liquid (lysate) and the second liquid that can more easily obtain the pressure reduction effect.
(a) The second liquid has a faster evaporation rate than the first liquid;
(b) The second liquid has a lower surface tension than the first liquid;
(c) The second liquid has a larger contact angle with the membrane than the first liquid;
(d) The viscosity of the second liquid is smaller than that of the first liquid.

In a case where the main component of the first liquid is water, examples of the second liquid satisfying one or more of the above-mentioned conditions include a solution containing 10% or more of an alcohol having four or less carbon atoms. More preferably, a solution containing 30% or more of an alcohol having three or less carbon atoms is exemplified. Even more preferably, a solution containing 40% or more of ethanol is exemplified. In addition, an appropriate second liquid may be selected according to the composition of the first liquid, or the first liquid may be selected according to the composition of the second liquid.

According to the first example (experimental result) of the present disclosure, the required pressure can be reduced. By reducing the required pressure, a high-density purification membrane can be installed in a structurally weak flow path chip. Here, examples of the structurally weak chip include a valve and a chip bonded together, and a chip using a soft material. Manufacturing a structurally weak chip has advantages such as reduction in chip cost and high functionality of the chip. In addition, by lowering the required pressure, it is possible to efficiently advance a chemical reaction which is inhibited by applying a high pressure. Furthermore, the measurement of the biomolecule can be facilitated by applying a high pressure.

In addition to lowering the pressure, the time required for transporting the solution can be shortened by using the technology of the present disclosure. By using the technology of the present disclosure, it is possible to prevent the membrane from drying after the lysate passes and before washing, so that it is possible to accept advantages such as an increase in yield of biomolecules and an increase in washing efficiency.

### (iv) Membranes for DNA Recovery

In the biomolecule analyzer 100, highly efficient DNA recovery can be realized by installing a high-density membrane. There is a “particle retention size” as an index of pore fineness. This particle retention size means that particles having a particle diameter equal to or larger than the value described in the particle retention size are retained in the membrane. That is, the smaller the value of the particle retention size is, the finer the membrane pore is. The membrane used as the purification membrane can have a particle retention size of 100 μm or more. For example, it is desirable to use a finer pore membrane than the “Fusion 5” membrane sold by Whatman. Examples of a membrane capable of recovering DNA with higher efficiency include a membrane called “GF/D” sold by Whatman. The particle retention size of this membrane is 2.7 μm. Examples of a membrane capable of recovering DNA with higher efficiency include a membrane called “GF/F” sold by Whatman. The particle retention size of this membrane is 0.7 μm.

Highly efficient DNA recovery can be realized by stacking a plurality of membranes. For example, in the case of GF/F, DNA can be recovered more efficiently by stacking two or more sheets than by purifying only one sheet. The thickness of the membrane is desirably 0.001 mm or more. In the case of GF/F, the thickness of the membrane is 0.6 mm.

### (v) Membrane Chamber 108

The volume of the membrane chamber 108 is equal to or less than 30% of the volume of the lysis chamber 101 or the wash buffer chamber 105. The cross-sectional area in the direction perpendicular to the traveling direction of the flow path through which the two liquids commonly pass is 50% or less of the maximum cross-sectional area of the chamber. The volume of the flow path through which the two liquids commonly pass is 50% or less with respect to each of the two liquids. Therefore, the lysate and the wash buffer are not mixed more than 50% before the waste liquid chamber. Therefore, even if the solution is transported using the technology of the present disclosure, the binding efficiency of DNA is not significantly reduced.

The membrane chamber 108 is 0.1 μL to 1 mL in size. As the membrane chamber 108 is smaller, the loss at the time of elution is reduced. Therefore, a more suitable size of the membrane chamber 108 is desirably 0.1 μL to 100 μL, and still more preferably 0.1 μL to 30 μL.

### (vi) Flow Path

The volume of the flow path 307 is 0.1 μL to 1 L (in a case where a long flow path is used, the volume of the flow path increases). In a case where the volume of the flow path 307 is larger than 1 L, it takes time to transport the solution. Conversely, in a case where the volume is small, it is necessary to narrow the flow path width or reduce the distance between the chambers, and the degree of freedom in design is reduced. In a case where a chamber is present outside the chip, the volume is desirably large. If the flow path is too thin, there is a concern that unexpected operation such as clogging of the flow path may occur. A more suitable volume of the flow path is 1 μL to 100 mL, and 30 μL to 100 mL in another example.

The volume of the flow path 307 can be the same as or larger than the volume of a space 108_1 above the purification membrane 102 in the membrane chamber 108.

In a case where drying is performed after purification, it is desirable to secure the thickness of the flow path to some extent. In this case, the thickness of the flow paths 302 and 303 is desirably 0.03 mm².

### <Process Switching Control>

### (i) Control Using Liquid Level Detection Sensor

A liquid level detection sensor can be used to switch between Processes I, II, III, IV, and V in FIG. 6. For example, when Process III is switched to Process IV, the liquid level detection sensors 313 and 314 are used. As the liquid level detection sensors 313 and 314, sensors that electrically, optically, sound waves, or dynamically detect can be used.

In the case of using the liquid level detection sensor 313, when switching from Process III to Process IV, a signal obtained by detecting that the liquid level in the waste liquid chamber 107 exceeds the liquid level detection sensor 313 may be used. Note that, the liquid level detection sensor 313 needs to be installed at a position where the liquid level in the waste liquid chamber 107 can be detected at the timing when the remaining amount of the lysate 113 in the lysis chamber 101 becomes less than 10%.

In the case of using the liquid level detection sensor 314, when switching from the process Procedure II to the process Procedure III, a signal obtained by detecting that the liquid level in the lysis chamber falls below the liquid level detection sensor 314 may be used. Note that, the liquid level detection sensor 314 needs to be installed at a position where the liquid level can be detected at the timing when the remaining amount of the lysate 113 in the lysis chamber 101 becomes less than 10%.

### (ii) Control by Pressure, Time, and the Like

Pre-set pressure and time may be used to switch between Processes I, II, III, and IV in FIG. 6. The pressure and the time may be adjusted by the operator. A mechanism for measuring viscosity may be provided in the lysis chamber 101 or the like.

A flow rate sensor or a pressure sensor may be installed at a specific location to define a process switching timing.

### Second Example

A second example will be described with reference to FIGS. 7, 11, and 12.

### <Configuration Example of Purification System 301 Including Main Part of Flow Path Chip 114>

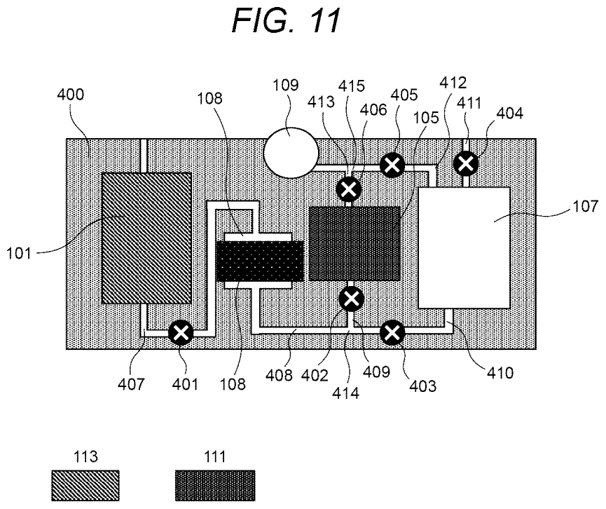

FIG. 11 is a diagram illustrating a configuration example of a purification system 400 including a main part of the flow path chip 114 according to the second example, that is, a main part of the flow path chip 114 at the time of completing or performing the sample lysing procedure 202.

The purification system 400 includes a lysis chamber 101, a wash buffer chamber 105, a waste liquid chamber 107, a membrane chamber 108, valves 401, 402, 403, 404, 405, and 406, flow paths 407, 408, 409, 410, 411, 412, and 413 connecting the chambers, and a port 109. The number of the ports 109 may not be 1, and one port may be installed for each function. Alternatively, for example, dedicated ports may be provided to the flow paths 413 and 412, respectively. The lysis chamber 101 holds the lysate 113 therein. The wash buffer chamber 105 holds the wash buffer 111 therein.

As illustrated in FIG. 11, the flow path 407 extending from the outlet port of the lysis chamber 101 is led to the inlet port of the membrane chamber 108. The flow path 408 extending from the outlet port of the membrane chamber 108 and the flow path 409 extending from the outlet port of the wash buffer chamber 105 join at a connection point (junction) 414 to form the flow path 410, which is led to an inlet port at a lower portion (bottom surface: not necessarily a bottom surface) of the waste liquid chamber 107. The flow path extending from the port 109 is divided into the flow path 412 and the flow path 413 at a branch point 415. The flow path 413 is led to an inlet port of the wash buffer chamber 105. The flow path 412 is led to an upper portion (top surface: not necessarily top surface) of the waste liquid chamber 107. The flow path 411 is also led to an upper portion (top surface: not necessarily a top surface) of the waste liquid chamber 107.

As illustrated in FIG. 11, the valve 401 is provided in the flow path 407. The valve 402 is provided in the flow path 409. The valve 403 is provided in the flow path 410. The valve 404 is provided in the flow path 411. The valve 405 is provided in the flow path 412. The valve 406 is provided in the flow path 413.

### <Purification Process>

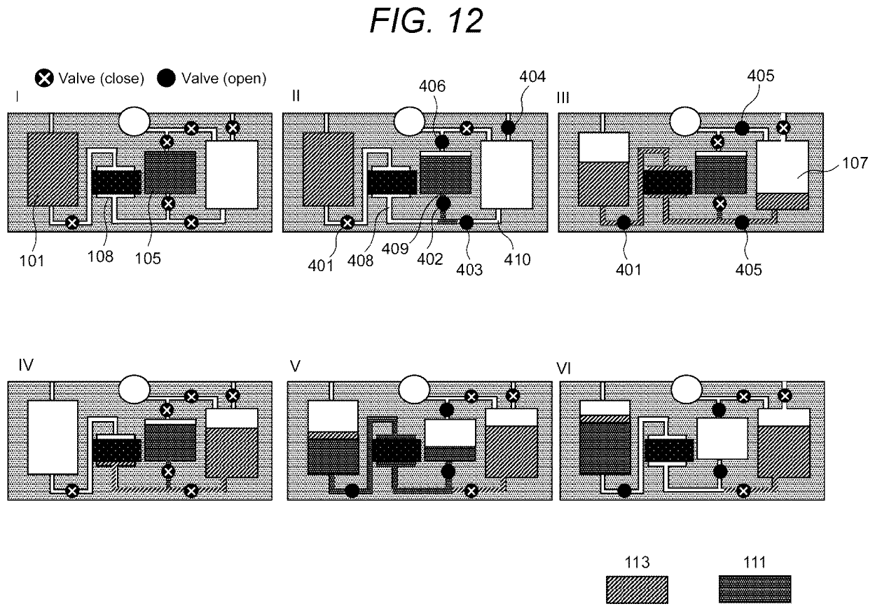

FIG. 12 is a diagram for explaining Purification Processes I to V according to the second example. The flowchart of the purification processes is similar to that of FIG. 7.

### (i) Process I

Process I shows the state during lysis or immediately after lysis is complete in the sample lysing procedure 202. At this time, the valves 401, 402, 403, 404, 405, and 406 are closed.

### (ii) Process II

In Process II, the valves 402, 406, 403 and 404 are opened. The wash buffer 111 is extruded from the wash buffer chamber 105 at a pressure of not more than 60 kPa for a time of not more than 30 seconds. At this time, the air in the flow path 409 moves to the flow path 408 or 410, and the flow path 409 is filled with the wash buffer 111. As described above, discharging the air in the flow path 409 in Process II is important for achieving continuous transport without sandwiching air between the lysate 113 and the wash buffer 111.

(iii) Process III

In Process III, the valves 402 and 406 are closed, the valves 401, 403, and 405 are opened. 900 μL of the lysate 113 is transported from the lysis chamber 101 to the waste liquid chamber 107 via the membrane chamber 108 for 2 minutes at an applied pressure of −60 kPa.

### (iv) Process IV

In Process IV, once all the lysate 113 has been transported to the membrane chamber 108, the valves 403 and 405 are closed and the valves 402 and 406 are opened. 500 μL of the wash buffer 111 is transported from wash the wash buffer chamber 105 to the lysis chamber 101 via the membrane chamber 108 for 3 minutes at an applied pressure of 60 kPa.

### (v) Process V

Process V shows the state in the middle of transporting the wash buffer 111 from the wash buffer chamber 105 to the lysis chamber 101 via the membrane chamber 108.

### (vi) Process VI

Process VI shows the state after a total or predetermined amount of wash buffer 111 has been transported from the wash buffer chamber 105 to the lysis chamber 101 via the membrane chamber 108.

By adopting the operation procedure as described above, it is possible to continuously transport the lysate 113 and the wash buffer 111 without sandwiching air between the lysate 113 and the wash buffer 111.

It goes without saying that the pressure and time applied in Process III of FIG. 12 are not limited to the above numerical values. It is necessary to have a combination of time and pressure at which 90% or more of the lysate 113 can be transported. The time and pressure required to transport almost all of the lysate 113 from the lysis chamber 101 to the purification membrane 102 may be separately verified i experiment and set in an implementation program.

### Third Example

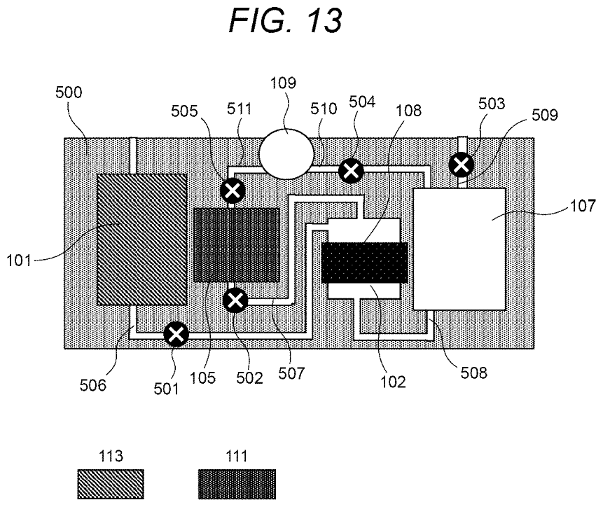

A third example will be described with reference to FIGS. 13, 14, and 15.

### <Configuration Example of Purification System 301 Including Main Part of Flow Path Chip 114>

FIG. 13 is a diagram illustrating a configuration example of a purification system 500 including a main part of the flow path chip 114 according to the third example, that is, a main part of the flow path chip 114 at the time of completing or performing the sample lysing procedure 202.

The purification system 500 includes a lysis chamber 101, a wash buffer chamber 105, a waste liquid chamber 107, a membrane chamber 108, valves 501, 502, 503, 504, and 505, flow paths 506, 507, 508, 509, 510, and 511 connecting the chambers, and a port 109. The number of the ports 109 may not be 1, and one port may be installed for each function. For example, dedicated ports may be provided in the flow paths 510 and 511, respectively. The lysis chamber 101 holds the lysate 113 therein. The wash buffer chamber 105 holds the wash buffer 111 therein.

As illustrated in FIG. 13, the flow path 506 extending from the outlet port of the lysis chamber 101 is led to one of two inlet ports (upper portion or top surface: not necessarily a top surface) of the membrane chamber 108. The flow path 508 extending from the outlet port of the membrane chamber 108 is led to an inlet port in a lower portion (bottom surface: not necessarily a bottom surface) of the waste liquid chamber 107. The flow path 507 extending from the outlet port of the wash buffer chamber 105 is led to the other inlet port of the membrane chamber 108. The flow path 511 extending from the port 109 is led to an inlet port of the wash buffer chamber 105. Another flow path 510 extending from the port 109 is led to an upper portion (top surface: not necessarily a top surface) of the waste liquid chamber 107. The flow path 509 is also led to an upper portion (top surface: not necessarily a top surface) of the waste liquid chamber 107.

As illustrated in FIG. 13, the valve 501 is provided in the flow path 506. The valve 502 is provided in the flow path 507. The valve 503 is provided in the flow path 509. The valve 504 is provided in the flow path 510. The valve 505 is provided in the flow path 511.

### <Purification Process>

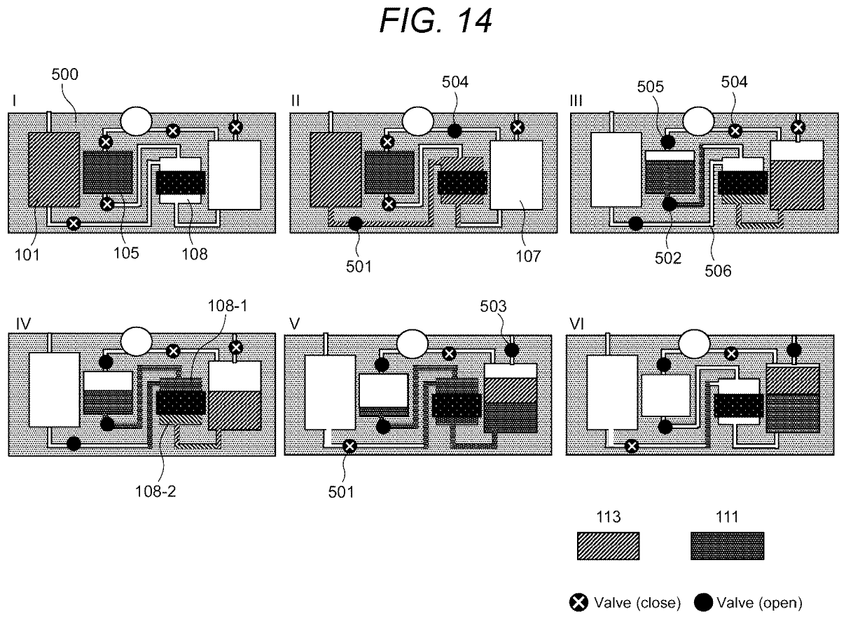

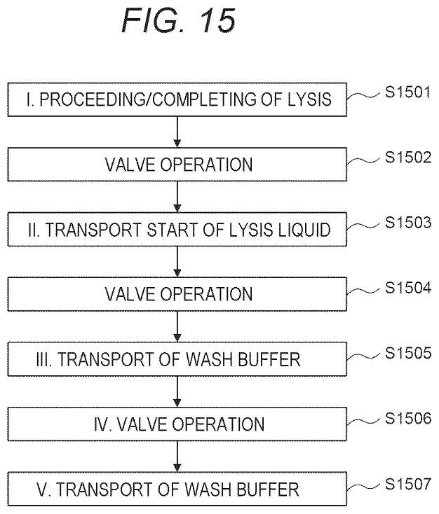

FIG. 14 is a diagram for explaining Purification Processes I to VI according to the third example. FIG. 15 is a flowchart corresponding to the purification process illustrated in FIG. 14.

### (i) Process I

Process I shows the state during lysis or immediately after lysis is complete in the sample lysing procedure 202 (step 1501). At this time, the valves 501, 502, 503, 504, and 505 are closed.

### (ii) Process II

In Process II, the valves 501 and 504 are opened (step 1502). 900 μL of the lysate 113 is transported from lysis chamber 101 to waste liquid chamber 107 via membrane chamber 108 for 2 minutes at an applied pressure of −60 kPa (step 1503).

(iii) Processes III and IV

In Process III, once all the lysate 113 has been transported to the membrane chamber 108, the valve 504 is closed, and the valves 502 and 505 are opened (step 1504). The wash buffer 111 is transported from the wash buffer chamber 105 towards the flow path 506 via the membrane chamber 108 for 30 seconds at an applied pressure of 30 kPa (step 1505). At this time, the air present in the space 108_1 on the inlet port side of the membrane chamber 108 moves to the flow path 506, and the space 108_1 of the membrane chamber 108 is filled with the wash buffer 111. A space 108_2 on the outlet port side of the membrane chamber 108 is filled with the lysate 113. As described above, it is important to discharge the air in the membrane chamber 108 to the flow path 506 in Process IV for achieving continuous transport without sandwiching the air between the lysate 113 and the wash buffer 111.

### (iv) Process

When the wash buffer starts to enter the flow path 506, the valve 501 is closed, and the valve 503 is opened (step 1506). The wash buffer 111 is transported from the wash buffer chamber 105 to the waste liquid chamber 107 via the membrane chamber 108 (step 1507).

### (v) Process VI

Process VI shows the state after a total or predetermined amount of wash buffer 111 has been transported from the wash buffer chamber 105 to the waste liquid chamber 107 via the membrane chamber 108.

By adopting the operation procedure as described above, it is possible to continuously transport the lysate 113 and the wash buffer 111 without sandwiching air between the lysate 113 and the wash buffer 111.

### Fourth Example

A fourth example will be described with reference to FIGS. 15, 16, and 17.

### <Configuration Example of Purification System 600 Including Main Part of Flow Path Chip 114>

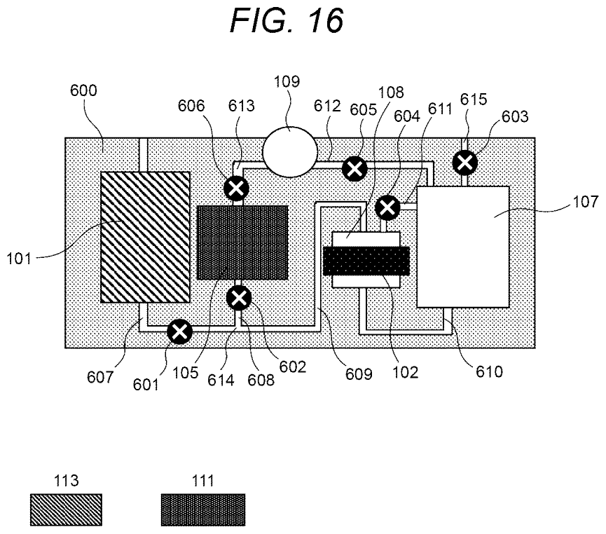

FIG. 16 is a diagram illustrating a configuration example of a purification system 600 including a main part of the flow path chip 114 according to the fourth example, that is, a main part of the flow path chip 114 at the time of completing or performing the sample lysing procedure 202.

The purification system 600 includes a lysis chamber 101, a wash buffer chamber 105, a waste liquid chamber 107, a membrane chamber 108, valves 601, 602, 603, 604, 605, and 606, flow paths 607, 608, 609, 610, 611, 612, and 613 connecting the chambers, and a port 109. The number of the ports 109 may not be 1, and one port may be installed for each function. For example, dedicated ports may be provided to the flow paths 612 and 613, respectively. The lysis chamber 101 holds the lysate 113 therein, and the wash buffer chamber 105 holds the wash buffer 111 therein.

As illustrated in FIG. 16, the flow path 606 extending from the outlet port of the lysis chamber 101 and the flow path 608 extending from the outlet port of the wash buffer chamber 105 join at a connection point (junction) 614 to form the flow path 609. The flow path 609 is led to an inlet port at an upper portion (top surface: not necessarily a top surface) of the membrane chamber 108. The flow path 610 extending from a outlet port provided in a lower portion (bottom surface: not necessarily a bottom surface) of the membrane chamber 108 is led to an inlet port provided in a lower portion (bottom surface: not necessarily a bottom surface) of the waste liquid chamber 107. The flow path 611 extending from a outlet port provided in an upper portion (top surface: not necessarily a top surface) of the membrane chamber 108 is led to an upper portion (side surface: not necessarily a side surface, and a top surface may be possible) of the waste liquid chamber 107. The flow path 613 extending from the port 109 is led to an inlet port of the wash buffer chamber 105. Another flow path 612 extending from the port 109 is led to an upper portion (top surface: not necessarily a top surface) of the waste liquid chamber 107. The flow path 615 is also led to an upper portion (top surface: not necessarily a top surface) of the waste liquid chamber 107.

As illustrated in FIG. 16, the valve 601 is provided in the flow path 607. The valve 602 is provided in the flow path 608. The valve 603 is provided in the flow path 615. The valve 604 is provided in the flow path 611. The valve 605 is provided in the flow path 612. The valve 606 is provided in the flow path 613.

### <Purification Process>

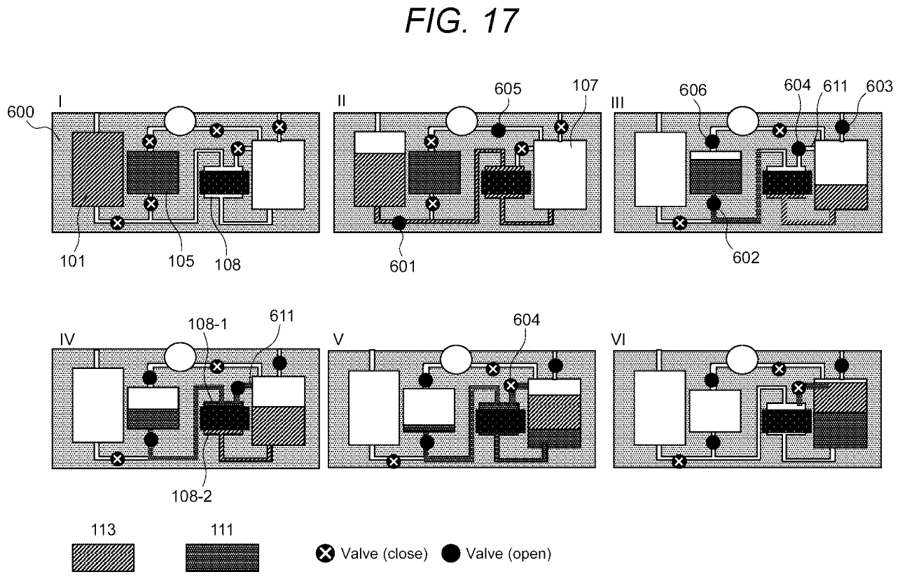

FIG. 17 is a diagram for explaining Purification Processes I to V according to the fourth example. The flowchart of the purification process is similar to that of FIG. 15.

### (i) Process I

Process I shows the state during lysis or immediately after lysis is complete in the sample lysing procedure 202. At this time, the valves 601, 602, 603, 604, 605, and 606 are closed.

### (ii) Process II

In Process II, the valves 601 and 605 are opened. 900 μL of the lysate 113 is transported from the lysis chamber 101 to the waste liquid chamber 107 via the membrane chamber 108 for 2 minutes at an applied pressure of −60 kPa.

(iii) Process III

In Process III, after all the lysate 113 is transported to the membrane chamber 108, the valves 601 and 605 are closed, and the valves 602, 606, 604, and 603 are opened. The wash buffer 111 is transported from the wash buffer chamber 105 toward the flow path 611 via the membrane chamber 108 for 30 seconds at an applied pressure of 30 kPa.

### (iv) Process IV and Process V

In Process IV, once the wash buffer 111 has entered the flow path 611, the valve 604 is closed. The wash buffer 111 is transported from the wash buffer chamber 105 to the waste liquid chamber 107 via the membrane chamber 108. At this time, the air present in the space 108_1 on the inlet port side of the membrane chamber 108 moves to the waste liquid chamber 107 via the flow path 611, and the space 108_1 of the membrane chamber 108 is filled with the wash buffer 111. A space 108_2 on the outlet port side of the membrane chamber 108 is filled with the lysate 113. As described above, it is important to discharge the air in the membrane chamber 108 to the waste liquid chamber 107 through the flow path 611 in Process IV for achieving continuous transport without sandwiching the air between the lysate 113 and the wash buffer 111.

### (v) Process VI

Process VI shows the state after a total or predetermined amount of wash buffer 111 has been transported from the wash buffer chamber 105 to the waste liquid chamber 107 via the membrane chamber 108.

By adopting the operation procedure as described above, it is possible to continuously transport the lysate 113 and the wash buffer 111 without sandwiching air between the lysate 113 and the wash buffer 111.

### Fifth Example

A fifth example is a derivative form of the first example. A purification system 301′ according to the fifth example has a configuration in which a valve 701 is added to the purification system 301 (see FIG. 6) according to the first example.

### <Purification Process>

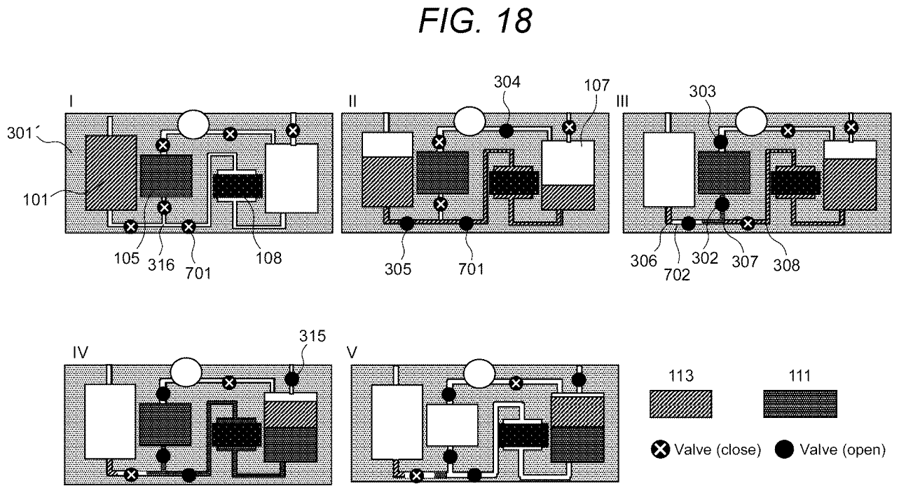

FIG. 18 is a diagram for explaining Purification Processes I to V according to the fifth example.

### (i) Process I

Process I shows the state during lysis or immediately after lysis is complete in the sample lysing procedure 202. At this time, the valves 302, 303, 304, 305, and 701 are closed.

### (ii) Process II

In Process II, the valves 305, 304, and 701 are opened. 900 μL of the lysate 113 is transported from the lysis chamber 101 to the waste liquid chamber 107 via the membrane chamber 108 for 1 minute at an applied pressure of −60 kPa.

(iii) Process III

In Process III, the valves 304 and 701 are closed before the air 702 following the transported lysate 113 exceeds the branch point (connection point (junction) 316 of the flow paths) of the flow paths 306 and 308 and the flow path 307, and the valves 302 and 303 are opened. The wash buffer 111 is transported from the wash buffer chamber 105 to the lysis chamber 101 via the flow path 306 for 30 seconds at an applied pressure of 30 kPa. At this time, the air in the flow path 307 moves to the flow path 308 or 306, and the flow path 307 is filled with the wash buffer 111. It is important to discharge the air in the flow path 307 in Process III for achieving continuous transport without sandwiching air between the lysate 113 and the wash buffer 111.

### (iv) Process IV

In Process IV, the valves 315 and 701 are opened. 500 μL of the wash buffer 111 is transported from the wash buffer chamber 105 to the waste liquid chamber 107 via the membrane chamber 108 for 3 minutes at 60 kPa.

### (v) Process V

Process V shows the state after a total or predetermined amount of wash buffer 111 has been transported from the wash buffer chamber 105 to the waste liquid chamber 107 via the membrane chamber 108.

By adopting the operation procedure as described above, it is possible to continuously transport the lysate 113 and the wash buffer 111 without sandwiching air between the lysate 113 and the wash buffer 111.

### Sixth Example

A sixth example is a derivative form of the second example. A purification system 400′ according to the sixth example has a configuration in which a valve 801 is added to the purification system 400 (see FIG. 11) according to the second example.

### <Purification Process>

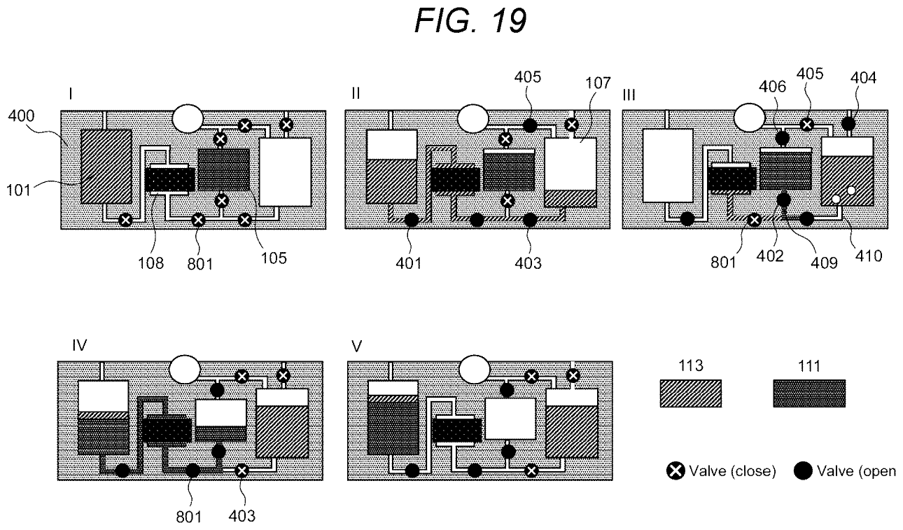

FIG. 19 is a diagram for explaining Purification Processes I to V according to the sixth example.

### (i) Process I

Process I shows the state during lysis or immediately after lysis is complete in the sample lysing procedure 202. At this time, the valves 401, 402, 403, 404, 405, 406, and 801 are closed.

### (ii) Process II

In Process II, the valves 401, 403, 405, and 801 are opened. 900 μL of the lysate 113 is transported from the lysis chamber 101 to the waste liquid chamber 107 via the membrane chamber 108 for 2 minutes at an applied pressure of −60 kPa.

(iii) Process III

In Process III, once all the lysate 113 is transported to the membrane chamber 108, the valves 405 and 801 are closed and the valves 402, 406, and 404 are opened. The wash buffer 111 is extruded from the wash buffer chamber 105 toward the waste liquid chamber 107 at a pressure of 30 kPa or less for a time of 30 seconds or less. At this time, the air in the flow path 409 moves to the flow path 410 or the waste liquid chamber 107. At this time, the air in the flow path 409 moves to the flow path 408 or 410, and the flow path 409 is filled with the wash buffer 111. As described above, it is important to discharge the air in the flow path 409 in Process III for achieving continuous transport without sandwiching the air between the lysate 113 and the wash buffer 111.

### (iv) Process IV

In Process IV, the valve 403 is closed and the valve 801 is opened. 500 μL of the wash buffer 111 is transported from the wash buffer chamber 105 to the lysis chamber 101 via the membrane chamber 108 for 3 minutes at 60 kPa.

### (v) Process V

Process V shows the state after a total or predetermined amount of wash buffer 111 has been transported from the wash buffer chamber 105 to the lysis chamber 101 via the membrane chamber 108.

By adopting the operation procedure as described above, it is possible to continuously transport the lysate 113 and the wash buffer 111 without sandwiching air between the lysate 113 and the wash buffer 111.

### (3) Supplementary Description of Examples

(i) In the case of the first example, in order to continuously transport the wash buffer and the lysate, it is necessary to switch from Process III to Process IV illustrated in FIG. 6 at the correct timing. If the transport time of the lysate 113 is too long, air enters the flow path 308. If the transport time is too short, a large amount of the lysate 113 remains in the lysis chamber 101, and the yield decreases. Therefore, it is necessary to perform the transport with high reproducibility or to define the transport time by the liquid level detection sensor.

However, in a case where the sample type varies, or the viscosity of the liquid is high, the reproducibility of the transport of the lysate 113 is low. In the case of using the liquid level detection sensor, since the number of components of the device increases, the cost increases. There is also a risk that the liquid level detection sensor does not operate correctly.

On the other hand, in the switching of the second example from Process III to Process IV illustrated in FIG. 11, the switching of the third example from Process II to Process III illustrated in FIG. 14, and the switching of the fourth example from Process II to Process III illustrated in FIG. 17, the wash buffer 111 and the lysate 113 can be continuously transported even if the time required for transporting the lysate 113 is exceeded. Therefore, in these examples, even if there is no liquid level detection sensor used in the first example, it is possible to realize a configuration in which the liquid level detection sensor is unnecessary while maintaining the yield.

(ii) The lysate 113 includes a polymer derived from a sample, a particle, a precipitate derived from a mixture with a lysis buffer, and the like. These are caught by the purification membrane at the time of transporting the lysate 113, which may cause a decrease in the efficiency of transporting the wash buffer 111 and the eluate at the subsequent stage or a decrease in the efficiency of transporting the fluid (air, nitrogen, and other gases) at the time of drying.

In this regard, in the case of the third example, the wash buffer 111 is caused to flow from the side opposite to the lysate 113. Thereby, there is also an effect of pressing an object caught on the membrane at the time of transporting the lysate to realize smooth transport.

(iii) In the case of the third example, the fourth example, the fifth example (a derivative form of the first example), and the sixth example (a derivative form of the second example) is not necessary to divide the transport of the wash buffer 111 into a plurality of times. Therefore, the wash buffer chamber 105 does not need to have a structure corresponding to a plurality of times of transport. For example, as the reagent chamber, a reagent transport pack using an actuator as shown in US 2006/134773 A1 may be used. However, in the case of the fifth example (a derivative form of the first example) and the sixth example (a derivative form of the second example), unless the valve 701 or the valve 801 is provided, there is a possibility that the fluid (air, nitrogen, and other gases) moves to the membrane chamber 108 side. Therefore, although the transport is possible without the valve 701 or the valve 801, the valve 701 or 801 can be provided to realize further stable solution transport. The flow path of the third example tends to be longer than that of the first example. The flow path of the fourth example requires an additional flow path to that of the first example.

### (4) Summary of Examples

In each example, in a flow path having a purification membrane, it is possible to continuously transport two kinds of solutions to a site where the membrane is installed without installing a dedicated configuration in a flow path chip for removing bubbles, and it is possible to reduce the pressure required for solution transport. As a result, the number of gas-liquid interfaces having a high Laplace pressure can be reduced or eliminated. Further, the volume of the fluid (air, nitrogen, and other gases) that needs to be transported in a wet state of the membrane can be reduced or eliminated.

(i) According to the first example (see FIGS. 5 and 6), the purification system (biomolecule analyzer) 301 has the flow path in which the membrane chamber 108 is disposed between the lysis chamber (first chamber) 101 and the wash buffer chamber (second chamber) 105, and the waste liquid chamber 107. The computer 115 controls the transport of the wash buffer (second liquid) 111 until the wash buffer exceeds at least the junction 316 between the flow paths 306 to 309 (first flow path) led from the lysis chamber 101 to the waste liquid chamber 107 and the flow path 307 (second flow path) extending from the wash buffer chamber (second chamber) 105, and discharges the fluid (air, nitrogen, and other gases) from the flow path 307 (second flow path). Next, the computer 115 controls the transport of the lysate (first liquid) 113 from the lysis chamber (first chamber) 101 to the waste liquid chamber 107 via the membrane chamber 108. Then, the computer 115 controls the transport of the wash buffer (second liquid) 111 in the wash buffer chamber (second chamber) 105 from the wash buffer chamber (second chamber) 105 to the waste liquid chamber 107 via the membrane chamber 108. This makes it possible to continuously transport the lysate 113 and the wash buffer 111 to the waste liquid chamber 107 without mixing air between the lysate 113 and the wash buffer 111 during solution transport. Since the fluid (air, nitrogen, and other gases) is not mixed, the pressure during solution transport can be reduced (see FIG. 10). Therefore, even if the flow path is somewhat structurally weak, it can be adopted, and the manufacturing cost of the purification system 301 can be suppressed.

(ii) According to the second example (see FIGS. 11 and 12), the purification system (biomolecule analyzer) 400 has the flow path in which the membrane chamber 108 is disposed between the lysis chamber (first chamber) 101 and the wash buffer chamber (second chamber) 105. The membrane chamber 108 and the wash buffer chamber 105 are connected to the waste liquid chamber 107. The computer 115 controls the transport of the wash buffer (second liquid) 111 until the wash buffer exceeds at least the junction 414 between the flow paths 407 to 408 (first flow path) led from the lysis chamber (first chamber) 101 to the waste liquid chamber 107 and the flow path 409 (second flow path) extending from the wash buffer chamber (second chamber) 105, and discharges the fluid (air, nitrogen, and other gases) from the flow path 409 (second flow path). Next, the computer 115 controls the transport of the lysate (first liquid) 113 from the lysis chamber (first chamber) 101 to the waste liquid chamber 107 via the membrane chamber 108. Then, the computer 115 controls the transport of the wash buffer (second liquid) 111 in the wash buffer chamber (second chamber) 105 from the wash buffer chamber (second chamber) 105 to the lysis chamber (first chamber) 101 via the membrane chamber 108. This makes it possible to transport the lysate 113 to the waste liquid chamber 107 and then continuously transport the wash buffer 111 to the lysis chamber 101 without mixing a fluid (air, nitrogen, and other gases) between the lysate 113 and the wash buffer 111 during solution transport. Since the fluid (air, nitrogen, and other gases) is not mixed, the pressure during solution transport can be reduced (similarly to the first example, see FIG. 10). Therefore, even if the flow path is somewhat structurally weak, it can be adopted, and the manufacturing cost of the purification system 400 can be suppressed.

(iii) According to the third example (see FIGS. 13 and 12), the purification system (biomolecule analyzer) 500 has the flow path in which the membrane chamber has a first inlet port led to the lysis chamber (first chamber) 101, a second inlet port led to the wash buffer chamber (second chamber) 105 on the upstream side, and an outlet port led to the waste liquid chamber 107. The flow path 506 (first flow path) extended from the lysis chamber (first chamber) 101 is led to the first inlet port of the membrane chamber 108. The flow path 507 (second flow path) extended from the wash buffer chamber (second chamber) 105 is led to the second inlet port of the membrane chamber 108. The flow path 508 (third flow path) extended from the outlet port of the membrane chamber 108 is led to the waste liquid chamber 107. The computer 115 transports the lysate (first liquid) 113 from the lysis chamber (first chamber) 101 to the waste liquid chamber 107 via the membrane chamber 108. Next, the computer 115 transports the wash buffer (second liquid) from the wash buffer chamber (second chamber) 105 to the space 108_1 between the first and second inlet ports of the membrane chamber 108 and the purification membrane of the membrane chamber 108 via the second inlet port of the membrane chamber 108, and discharges the wash buffer (second liquid) 111 from the first inlet port of the membrane chamber 108 to the flow path 506 (first flow path) side in a state where the space 108_1 is filled with the wash buffer (second liquid) 111. Then, the computer 115 transports the wash buffer (second liquid) from the wash buffer chamber (second chamber) to the waste liquid chamber 107 via the membrane chamber 108 in a state where the wash buffer (second liquid) 111 is present on the flow path 506 (first flow path) side. This makes it possible to continuously transport the lysate 113 and the wash buffer 111 to the waste liquid chamber 107 without mixing a fluid (air, nitrogen, and other gases) between the lysate 113 and the wash buffer 111 during solution transport. Since the fluid (air, nitrogen, and other gases) is not mixed, the pressure during solution transport can be reduced (similarly to the first example, see FIG. 10). Therefore, even if the flow path is somewhat structurally weak, it can be adopted, and the manufacturing cost of the purification system 500 can be suppressed.

(iv) According to the fourth example (see FIGS. 16 and 17), the purification system (biomolecule analyzer) 600 includes the plow path in which a membrane chamber 108 has a purification membrane 102, an inlet port through which a lysis chamber (first chamber) 101 and a wash buffer chamber (second chamber) 105 are led via a flow path 609, a communication port with a waste liquid chamber 107, and an outlet port. The plow path of the purification system (biomolecule analyzer) 600 has the flow paths 607 to 609 (first flow path) extending from the lysis chamber (first chamber) 101 and led to the inlet port of the membrane chamber 108, a flow path 608 (second flow path) extending from the wash buffer chamber r (second chamber) 105 to a junction 614 on the flow paths 607 to 609 (first flow path), a flow path 611 (communication flow path) leading the communication port provided in a first space 108_1 between the inlet port of the membrane chamber 108 and the purification membrane and the waste liquid chamber 107, and a flow path 610 (third flow path) provided from the outlet port of the membrane chamber 108 and leading to the waste liquid chamber 107. The computer 115 transports the lysate (first liquid) 113 from the lysis chamber (first chamber) 101 to the waste liquid chamber 107 via the membrane chamber 108. Next, the computer 115 transports the wash buffer (second liquid) 113 from the wash buffer chamber (second chamber) 105 to the first space 108_1 and the flow path 611 (communication flow path) through the inlet port of the membrane chamber 108. Then, the computer 115 transports the wash buffer (second liquid) 111 from the wash buffer chamber (second chamber) 105 to the waste liquid chamber 107 via the membrane chamber 108 in a state where the first space 108_1 and the flow path 611 (communication flow path) are filled with the wash buffer (second liquid) 111. This makes it possible to continuously transport the lysate 113 and the wash buffer 111 to the waste liquid chamber 107 without mixing a fluid (air, nitrogen, and other gases) between the lysate 113 and the wash buffer 111 during solution transport. Since the fluid (air, nitrogen, and other gases) is not mixed, the pressure during transport can be reduced (similarly to the first example, see FIG. 10). Therefore, even if the flow path is somewhat structurally weak, it can be adopted, and the manufacturing cost of the purification system 600 can be suppressed.

### REFERENCE SIGNS LIST

100 biomolecule analyzer
101 lysis chamber
102 purification membrane
103 reaction chamber
104 lysis buffer chamber
105 wash buffer chamber
106 reagent chamber
107 waste liquid chamber
108 membrane chamber
109 port
114 flow path chip
115 computer
301, 301′, 400, 400′, 500, 600 purification system
313, 314 liquid level detection sensor

1. A method for controlling liquid transport in a flow path of a biomolecule analyzer by a computer, wherein
the biomolecule analyzer includes a first chamber storing a first liquid, a second chamber storing a second liquid, a membrane chamber having a purification membrane, and a waste liquid chamber,
the method comprises:
controlling, by the computer, transport of the second liquid until the second liquid exceeds at least a junction between a first flow path leading from the first chamber to the waste liquid chamber and a second flow path extending from the second chamber, and discharging a fluid different from the first and second liquids from the second flow path;
controlling, by the computer, transport of the first liquid from the first chamber to the waste liquid chamber via the membrane chamber; and
controlling, by the computer, transport of the second liquid in the second chamber from the second chamber to the membrane chamber.

2. The method according to claim 1, wherein
the membrane chamber is disposed between the first chamber and the second chamber, and the waste liquid chamber, and
the method further comprises:
controlling, by the computer, further transport of the second liquid transported to the membrane chamber to the waste liquid chamber.

3. The method according to claim 1, wherein
the membrane chamber is disposed between the first chamber and the second chamber, and
the method further comprises:
controlling, by the computer, further transport of the second liquid transported to the membrane chamber to the first chamber.

4. The method according to claim 1, wherein
the computer is configured to control applied pressure and opening and closing of a valve in response to input information on flow rates of the first liquid and the second liquid, and execute each transport of the first liquid and the second liquid.

5. The method according to claim 4, wherein
the membrane chamber is disposed between the first chamber and the second chamber, and the waste liquid chamber, and
the computer is configured to (i) transport the second liquid to exceed at least the junction by closing a first valve provided closer to the first chamber than the junction in the first flow path, opening a second valve provided in the second flow path, and applying a pressure to liquid, (ii) then, transport the first liquid from the first chamber to the waste liquid chamber via the membrane chamber by closing the second valve, opening the first valve, and applying a pressure to liquid, and (iii) further, transport the second liquid from the second chamber to the waste liquid chamber via the membrane chamber by closing the first valve, opening the second valve again, and applying a pressure to liquid.

6. The method according to claim 4, wherein
the membrane chamber is disposed between the first chamber and the second chamber, and
the computer is configured to (i) transport the second liquid to exceed at least the junction by closing a first valve provided between the first chamber and the membrane chamber, opening a second valve provided in the second flow path and a third valve provided between the junction and the waste liquid chamber, and applying a pressure to liquid, (ii) then transport the first liquid from the first chamber to the waste liquid chamber via the membrane chamber by closing the second valve, opening the first and third valves, and applying a pressure to liquid, and (iii) further transport the second liquid from the second chamber to the first chamber via the membrane chamber by closing the third valve, opening the first and second valves, and applying a pressure to liquid.

7. The method according to claim 4, wherein
the membrane chamber is disposed between the first chamber and the second chamber, and the waste liquid chamber, and
the computer is configured to (i) transport the first liquid from the first chamber to the waste liquid chamber via the membrane chamber to fill a flow path from the third valve to an inlet port of the waste liquid chamber with the first liquid by opening a first valve provided between the junction and the first chamber and a second valve provided between the junction and the membrane chamber, closing a third valve provided in the second flow path, and applying a pressure to liquid, (ii) then transport the second liquid to exceed at least the junction by closing the second valve, opening the first and third valves, and applying a pressure to liquid, and (iii) further transport the second liquid from the second chamber to the waste liquid chamber via the membrane chamber by closing the first and second valves, opening the third valve, and applying a pressure to liquid.

8. The method according to claim 4, wherein
the membrane chamber is disposed between the first chamber and the second chamber, and
the computer is configured to (i) transport the first liquid from the first chamber to the waste liquid chamber via the membrane chamber by opening a first valve provided between the first chamber and the membrane chamber, a second valve provided between the membrane chamber and the junction, and a third valve provided between the junction and the waste liquid chamber, closing a fourth valve provided in the second flow path, and applying a pressure to liquid, (ii) then transport the first liquid to at least exceed the junction, (iii) then transport the second liquid from the second chamber toward the waste liquid chamber to discharge a fluid different from the first liquid and the second liquid contained in the second flow path to the waste liquid chamber by closing the second valve while maintaining a state in which a space between the purification membrane and a first liquid outlet port of the membrane chamber and a flow path between the first liquid outlet port and the second valve are filled with the first liquid, opening the third valve and the fourth valve, and applying a pressure to liquid, and (iv) further transports the second liquid from the second chamber to the first chamber via the membrane chamber by closing the third valve, opening the first valve, the second valve, and the fourth valve, and applying a pressure to liquid.

9. The method according to claim 1, wherein
the first flow path connected to the membrane chamber has a cross-sectional area of 314 mm² or less.

10. The method according to claim 1, wherein
the purification membrane is capable of holding particles of 0.1 μm or more.

11. The method according to claim 1, wherein
a composition of the purification membrane is silica.

12. The method according to claim 1, wherein
the first liquid contains one or more molecules selected from the group consisting; a biopolymer containing a nucleic acid, a protein, a lipid, or a polysaccharide, a biomonomer containing an amino acid, a lipid, a sugar, or a nucleobase, and a substance having a molecule that contains a derivative of the biopolymer or the biomonomer in a structure.

13. The method according to claim 1, wherein
the second liquid has a higher evaporation rate, a lower surface tension, or a larger contact angle with respect to a membrane than the first liquid.

14. The method according to claim 1, wherein
the first liquid is a lysate, the second liquid is a wash buffer, and the fluid is air.

15. The method according to claim 1, wherein
after the first liquid passes through the purification membrane, the computer is configured to transport the first and second liquids at a pressure lower than a pressure required for the fluid to pass through the purification membrane.

16. The method according to claim 4, wherein
the computer is configured to define switching timing of transport of the first liquid and the second liquid by a liquid level detection sensor, time, pressure, or a combination thereof.

17. The method according to claim 1, wherein
a volume of the second flow path is equal to or larger than a volume of a first space between the purification membrane and an inlet port of the membrane chamber.

18.-23. (canceled)

24. A biomolecule purification system comprising:
a biomolecule analyzer having a flow path; and
a computer configured to control liquid transport in the flow path, wherein
the biomolecule analyzer includes:
a first chamber that stores a first liquid;
a second chamber that stores a second liquid;
a waste liquid chamber; and
a membrane chamber having a purification membrane and disposed between the first chamber and the second chamber and the waste liquid chamber, and
the computer is configured to execute:
controlling transport of the second liquid until the second liquid exceeds at least a junction between a first flow path leading from the first chamber to the waste liquid chamber and a second flow path extending from the second chamber, and discharging a fluid different from the first and second liquids from the second flow path;
controlling transport of the first liquid from the first chamber to the waste liquid chamber via the membrane chamber; and
controlling transport of the second liquid in the second chamber from the second chamber to the waste liquid chamber via the membrane chamber.

25. A biomolecule purification system comprising:
a biomolecule analyzer having a flow path; and
a computer configured to control liquid transport in the flow path, wherein
the biomolecule analyzer includes:
a first chamber that stores a first liquid;
a second chamber that stores a second liquid;
a membrane chamber having a purification membrane and disposed between the first chamber and the second chamber; and
a waste liquid chamber, and
the computer is configured to execute:
controlling transport of the second liquid until the second liquid exceeds at least a junction between a first flow path leading from the first chamber to the waste liquid chamber and a second flow path extending from the second chamber, and discharging a fluid different from the first and second liquids from the second flow path;
controlling transport of the first liquid from the first chamber to the waste liquid chamber via the membrane chamber; and
controlling transport of the second liquid in the second chamber from the second chamber to the first chamber via the membrane chamber.

26.-28. (canceled)
